(19) United States
(12) Patent Application Publication
(10) Pub. No.: US 2022/0281419 A1
(43) Pub. Date: Sep. 8, 2022

(54) Utility Water from a Vehicle

(71) Applicants: Guy Raviv, Hasolelim (IL); Itay Alon, Hasolelim (IL); Gal Itah, Kibbutz Yifat (IL)

(72) Inventors: Guy Raviv, Hasolelim (IL); Itay Alon, Hasolelim (IL); Gal Itah, Kibbutz Yifat (IL)

(21) Appl. No.: 17/189,299

(22) Filed: Mar. 2, 2021

(51) Int. Cl. B60S 1/48; B60S 1/50

(52) U.S. Cl. CPC B60S 1/481; B60S 1/50

(57) ABSTRACT

Some embodiments of the current invention relate to production and exploitation of water for the use in various systems of a vehicle. For example, the system may collect available water (for example condensate from an air conditioner) and/or store the water and/or provide the water for use in or around the vehicle, for example to a windshield washer reservoir. In some embodiments, the system includes easily installed components. For example, there may be a self-contained collection unit that may be installed and/or adapted to various vehicles. Optionally, extra elements and/or modular elements may be added to the self-contained unit and/or adapted to a particular application and/or vehicle. For example, a utility tank may be provided and/or attached to the collection unit.

### FIELD AND BACKGROUND OF THE INVENTION

The present invention, in some embodiments thereof, relates to production and/or exploitation of water in a vehicle and, more particularly, but not exclusively, to an easily installed water system for vehicles.

U.S. Patent Publication no. 2004/0237561 appears to disclose “A system for utilizing water originating from an air conditioning system in order to supply water to an automobile windshield wiper system, includes air conditioning generating equipment for an automobile, the air conditioning generating equipment including a compressor, a condenser and an evaporating compartment; a water-collecting container positioned below a level of the evaporating compartment; first tubing for connecting the evaporating compartment to the water-collecting container to supply water from the evaporating compartment to the water-collecting container; second tubing for connecting the water-collecting container to a windshield wiper system of the automobile; and a pump for pumping the water from the water-collecting container to the windshield wiper system through the second arrangement.”

U.S. Patent Publication no. 2013/0263956 appears to disclose “A vehicle includes a water supply system for water consumers and a cooling system having a drain line for draining condensate water precipitated during operation of the cooling system. The drain line of the cooling system is connected to at least one water consumer.”

U.S. Patent Publication no. 2015/0027158 appears to disclose “A system, designed to transport condensed water from the vehicle's air conditioner to the vehicle's windshield washer reservoir that comprises an air conditioner, a reservoir, and tubing. The tubing transports condensed water from the air conditioner to the reservoir. The system may also include a condensed water collection container and a pump. One tube transports the condensed water from the air conditioner to the condensed water collection container, and a second tube transports water from the condensed water collection container to the windshield washer reservoir via the pump. The invention also refers to a kit that comprises two tubes, a condensed water collection container, and a pump and is designed to transport condensed water from the air conditioner to the reservoir.”

U.S. Patent Publication no. 2013/0056473 appears to disclose “Apparatus for providing a water supply for an agricultural vehicle includes an elongate cylindrical container for receiving water attached by straps to an exterior frame member of the vehicle at one side. A discharge pipe of the container has a valve at hand height for a user standing at the one side for discharge downwardly of water contained in the container. The container is supplied by a flexible pipe attached to a discharge nozzle of an air conditioning system of the vehicle to collect condensate therefrom.”

U.S. Pat. No. 5,651,259 appears to disclose “A method and apparatus are described for retrieving condensed fluid from an air conditioner in a vehicle, storing the collected fluid for subsequent use, and transferring the retrieved fluid to a reservoir in the vehicle. The method and apparatus described allow manual distribution or automatic distribution of the fluid.”

U.S. Pat. No. 9,650,018 appears to disclose “A system and method of collecting and conditioning rainwater and other moisture, such as dew, from a windshield of a vehicle and utilizing the collected fluid to replenish the fluids in the windshield washer reservoir. A collection funnel is positioned on a vehicle in order to collect rainwater and other moisture. Rainwater and other fluids from the collection funnel are directed to a conditioning cartridge where the water is de-ionized and windshield washer fluid is added. The cartridges are designed to be single replaceable units. The mixed fluid from the mixing cartridge is directed to the pre-existing windshield washer reservoir.”

Chinese Utility Model no. 204678624U appears to disclose “A kind of electric automobile air conditioner device for recycling condensed water, comprise HVAC, compressor exhaust pipe, condenser, it is characterized in that: described air conditioner condensate water reclamation device is enclosed within compressor exhaust pipe, two ends riveted joint sealing, this device has two openings, and one of them is connected with HVAC weep pipe, entering for condensed water, another one is discharge outlet (opening vertically downward), completes the condensed water after heat exchange and gets rid of thus; Its operation principle: in air-conditioning work process, HVAC can produce a large amount of condensed waters, temperature is at about 10 degree, flow in liquid trap by weep pipe, liquid trap two ends seal, and the discharge outlet that the lower condensed water of temperature can flow to liquid trap along blast pipe goes out to discharge, in the process of flowing, condensed water can take away the partial heat (Tail Pipe Temperature is greatly about an 85 degree) of compressor exhaust pipe, the cold-producing medium of HTHP is played to the effect of precooling; This patent effectively reduces the power consumption of air-conditioning, reduces the impact of car load continual mileage when turning on the aircondition, and the feature such as installation, maintenance, convenient disassembly be easy to operate.”

### SUMMARY OF THE INVENTION

According to an aspect of some embodiments of the invention, there is provided a system for exploiting water in a vehicle including: an integrated collector unit including a tank, a pump, a controller; a fluid connection from the pump to a windshield washer reservoir of the vehicle; a utility tank including a fluid outlet accessible for human use.

According to some embodiments of the invention, the integrated collector unit further includes a water level sensor.

According to some embodiments of the invention, the water levels sensor includes a mechanical switch that activates the pump in response to an output of the water level sensor.

According to some embodiments of the invention, the water levels sensor sends an output to the controller.

According to some embodiments of the invention, the system further includes a water levels sensor for the windshield washer reservoir and wherein the water levels sensor for the windshield washer reservoir sends an output to the controller.

According to some embodiments of the invention, the system further includes a water levels sensor for the utility tank and wherein the sensor for the utility tank sends an output to the controller.

According to some embodiments of the invention, the system further includes a modular mount facilitating mounting of the integrated collector unit to different vehicles.

According to some embodiments of the invention, the modular mount is configured for absorbing vibration.

According to an aspect of some embodiments of the invention, there is provided a method of collecting water in a vehicle including: accumulating condensate to a collection tank; and pumping the condensate from the collection tank to a reservoir in the vehicle when a level water in the collection tank reaches a threshold.

According to some embodiments of the invention, the pumping is to a windshield washer reservoir.

According to some embodiments of the invention, the pumping is to a utility tank including a fluid outlet accessible for human use on the vehicle.

According to some embodiments of the invention, the accumulating is via gravity flow from an air conditioner of the vehicle.

According to an aspect of some embodiments of the invention, there is provided a method of retrofitting a vehicle with a water accumulation system including: mounting a water collection unit to the vehicle; connecting in inlet of the water collection unit to a condensate collector of the vehicle; connecting an outlet of the collection unit to a reservoir of the vehicle.

According to some embodiments of the invention, the method further includes attaching a quick connector to the reservoir and attaching the connecting of the outlet is to the quick connector.

According to some embodiments of the invention, the attaching includes at least one of replacing a cap of the reservoir with a cap including the quick connector, forming a hole in the cap of the reservoir and inserting the quick connector into the hole, and forming a hole in the reservoir and inserting the quick connector into the hole.

According to some embodiments of the invention, the method further includes: mounting a utility tank on the vehicle and wherein the connecting the outlet includes connecting the outlet to the utility tank.

According to some embodiments of the invention, the method further includes installing a user interface application onto a personal computing device of a user for use as a user interface of the water accumulation system.

According to some embodiments of the invention, the mounting is below a water source such that water flows from the water source to the collection unit by gravity flow.

According to an aspect of some embodiments of the invention, there is provided a kit for retrofitting a vehicle for water collection including: an integrated collector unit including a tank, a pump, a controller; a replacement cap for a water reservoir of the vehicle including a connection for input from the collector unit.

According to some embodiments of the invention, the integrated collector unit further includes a transceiver configured to communicate data to a mobile computing device of a user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of a collector unit in accordance with an embodiment of the current invention;

FIG. 1B is a cross sectional view of a collector unit in accordance with an embodiment of the current invention;

FIG. 2A illustrates a windshield washer fluid reservoir cap in accordance with an embodiment of the current invention;

FIG. 2B illustrates a windshield washer fluid reservoir cap attachment 234 in accordance with an embodiment of the current invention;

FIG. 3 is an illustration of a utility including a raised utility tank in a cargo section of the vehicle in accordance with an embodiment of the current invention;

FIG. 4 is an illustration of a utility including a concealed utility tank in a cargo section of the vehicle in accordance with an embodiment of the current invention;

FIG. 5 is a block diagram of a water exploitation system for a vehicle in accordance with an embodiment of the current invention;

FIG. 6 is a block diagram of a vehicle water collection system in accordance with an embodiment of the current invention;

FIG. 7 is a flow chart illustration of a method of exploiting water in accordance with an embodiment of the current invention;

FIG. 8 is a flow chart illustration of a method of installing a system to exploit water in a vehicle in accordance with an embodiment of the current invention;

FIG. 9 is a schematic illustration of a water collection system in accordance with an embodiment of the current invention;

FIG. 10 is a schematic illustration of a tank 1012 including an integrated pump 1010 in accordance with an embodiment of the current invention;

FIG. 11 is a schematic illustration of a system in which the control unit is integrated into a tank 1112 in accordance with an embodiment of the current invention; and

FIG. 12 is a schematic drawing of a water exploitation system mounted to utility vehicle in accordance with an embodiment of the current invention.

### DESCRIPTION OF SPECIFIC EMBODIMENTS OF THE INVENTION

The present invention, in some embodiments thereof, relates to production and/or exploitation of water in a vehicle and, more particularly, but not exclusively, to an easily installed water system for vehicles.

### Overview

An aspect of some embodiments of the current invention relates to production and exploitation of water for the use in various systems of a vehicle. For example, the system may collect available water (for example condensate from an air conditioner) and/or store the water and/or provide the water for use in or around the vehicle. In some embodiments, the system includes easily installed components. For example, there may be a self-contained unit that can be installed and/or adapted to various vehicles. Optionally, extra elements and/or modular elements may be added to the self-contained unit and/or adapted to a particular application and/or vehicle.

In some embodiments, the system includes a collection module and/or an application module. Optionally, the collection module may include a standard and/or self-contained system and/or the application module may be customized according to the vehicle and/or application. For example, the collection module may receive water from a condensate drain of an air conditioner. Optionally the collection module includes a tank. For example, the tank may have a capacity of from 1 to 10 liters and/or from 10 to 30 l and/or from 30 to 100. Optionally, a buoy (float/water level sensor) may be connected to an electronic circuit that operates a pump according to the water level in the tank. The pump optionally transfers the water to designated existing reservoirs in the vehicle for various uses and/or to an application module. For example, the pump may have a capacity of pumping between 0.1 to 1 l/hr and/or between 1 to 5 l/hr and/or between 5 to 30 l/hr and/or between 30 to 100 l/hr.

In some embodiments, system is installed in large vehicles used for hard-working purposes such as agricultural equipment (e.g., tractor, combine, etc.), trucks, trailers, buses, and pickups. The system optionally provides a utility tank to which collected water is sent. For example, the water may be used by various people for various purposes. For example, the operator (e.g., driver) may use the water for hygienic uses such as hand and foot washing (e.g., in order to provide the driver with a clean and safe environment) and/or for cleaning tools, pipe fittings, valves and more. Additionally or alternatively, the system may be installed and used on a variety of vehicles such as trucks, buses, RVs, pickups, and private cars. Optionally, a utility tank may have a capacity between 1 to 10 l and/or between 10 to 40 l and/or between 40 to 100 l and/or between 100 to 500 l.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

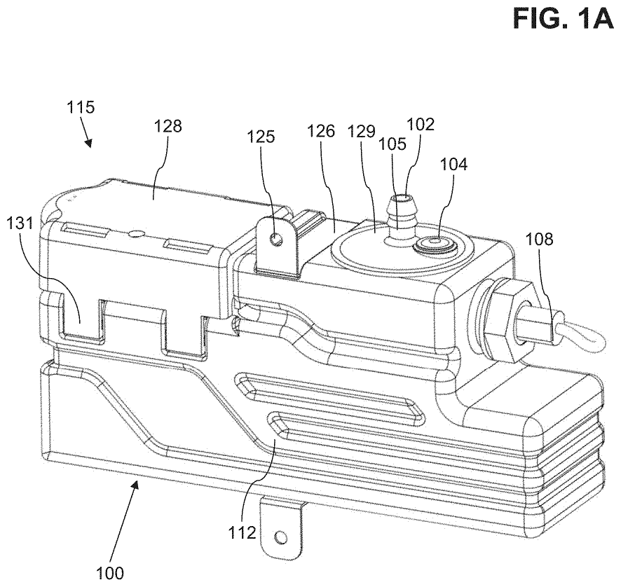

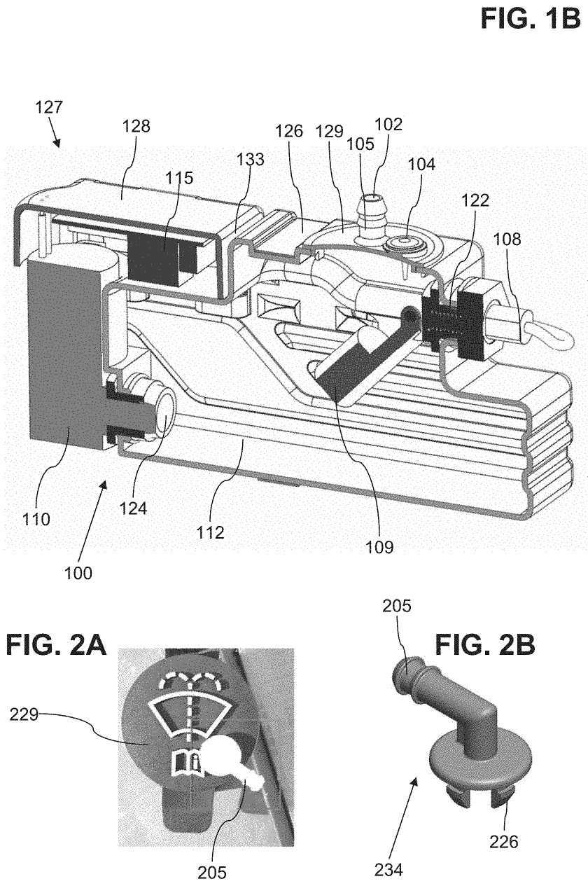

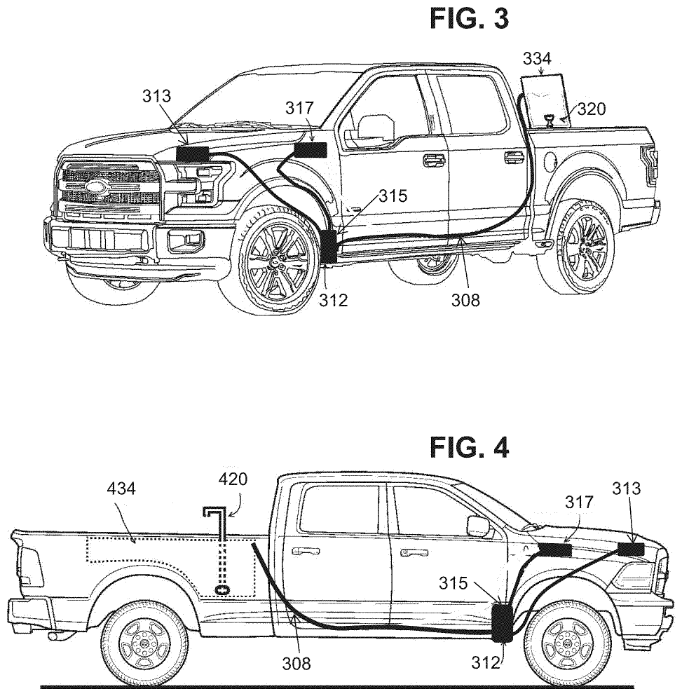

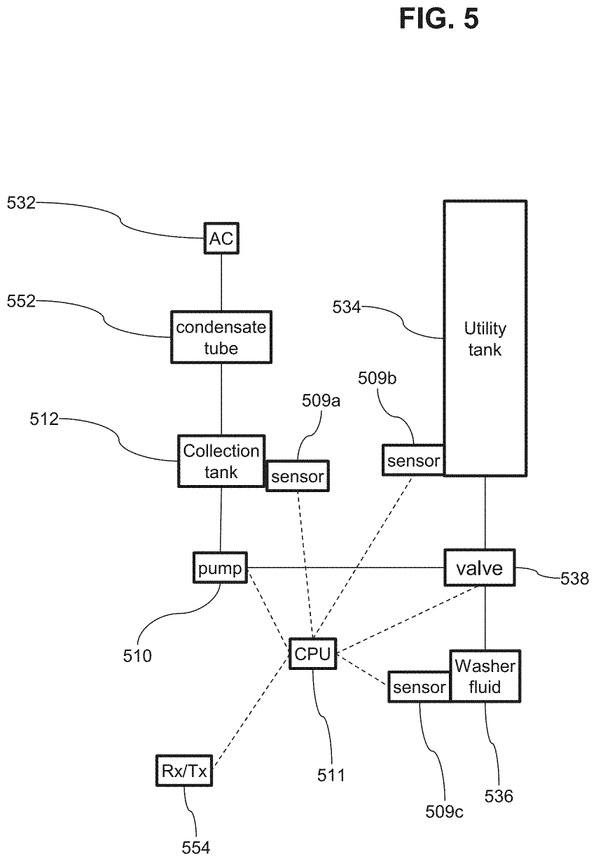

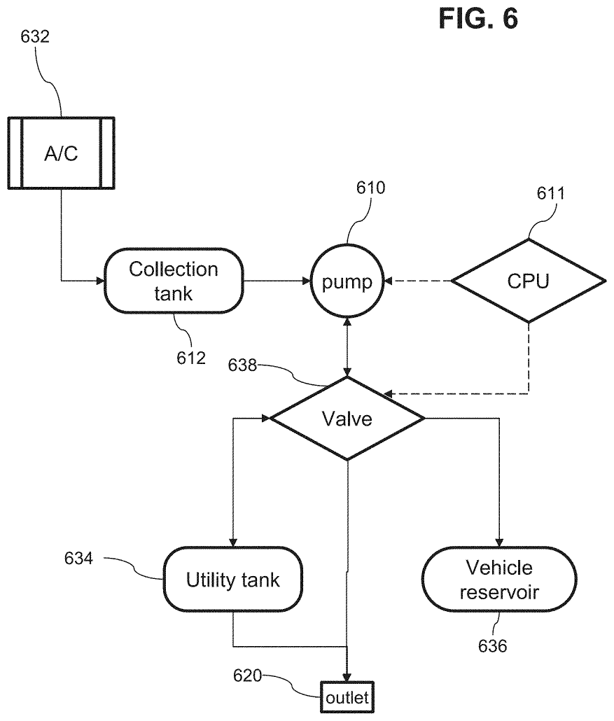

FIG. 1A is a schematic illustration of a collector unit in accordance with an embodiment of the current invention. FIG. 1B is a cross sectional view of a collector unit in accordance with an embodiment of the current invention. In some embodiments, a collector unit 100 may be designed for easy installation to various vehicles. For example, the unit 100, may be packaged as a single integrated unit, making installation easy with reduced installing of different units and/or interconnecting between units. The system 100 optionally includes a hydraulic quick connector 105, for example for quick connection between a collecting unit, a utility tank (for example 334, 434, 534, 634 of FIGS. 3, 4, 5, 6), and/or water reservoirs (for example, 536 636 of FIGS. 5, 6) of the vehicle. Additionally and/or alternatively, there may be an electrical quick connector for simple connection to a source of electrical power in the vehicle and/or between a collection unit 100 and a utility storage unit (for example 334, 434, 534, 634 of FIGS. 3, 4, 5, 6). In some embodiments, a collection unit 100 includes an integrated combination of a tank 112 for storing collected water, a pump 110, a controller 115, one or more connectors 105 and/or a mount 126. In some embodiments, a utility tank may be installed under the vehicle, on top of the vehicle, in a passenger compartment, in a luggage compartment, in a utility compartment, in a space inside a fender and/or in a space shielded by a fender. In some embodiments, there is no added utility tank, for example, the system supplies water to existing reservoirs of the vehicle.

In some embodiments, tank 112 includes an inlet cap 129. For example, the cap 129 may include a quick connector 105 and/or an inlet channel 102. For example, quick connector 105 may be configured for easy connection to an existing condensate drainage tube of a vehicle air conditioner. Optionally, there is a one-way valve 104 allow air to escape as water enters the tank 112. Additionally or alternatively, one-way valve 104 may serve as an overflow valve, for example to prevent water build up if the water is not pumped fast enough out of tank 112. Optionally, the unit includes an inlet 102.

In some embodiments, a collection unit 100 may include a mount 126 configured to attach to a vehicle. Optionally, the collection unit 100 may include a connecting feature and a modular mounting structure. Optionally, a different mounting structure may connect to the same connection feature facilitating mounting the collection unit to different vehicles. For example, in the embodiment of FIG. 1A, the mount 126 includes a band with a connector 125 for attachment to a vehicle. Optionally, unit 100 includes a groove for attachment to the band. Optionally, bands of different lengths and having differing connections configured to fit different vehicles may attach to the same groove.

In some embodiments, a collection unit 100 includes a control unit 115. Optionally, the control unit 115 may be above the tank 112 and/or sealed from contact with fluid in the tanks 112 (for example the control unit 115 may have a cover 128. Optionally, the control unit 115 is protected from vibrations of the vehicle. For example, the mount may be configured to absorb vibration (for example, the unit 100 may be suspended on bands that are elastic enough to absorb vibration). Alternatively or additionally, the control unit 128 may be attached to the collection unit 100 with a shock absorbing connector. For example, a portion of the tank 112 between the mount 126 and the control unit 115 may be configured to absorb shock and/or vibration (for example the tank may include a thin section 133 and/or a thin walled section and/or ridges that allow the tank to deform elastically and/or absorb shocks). Alternatively or additionally, the control unit 128 may be attached to other parts of the collection unit 100 by an energy absorbing connection (for example an elastic connector 131).

In some embodiments, a collection unit 100 may include an integral pump 110. For example, the pump 110 may be built into the unit 100 with an inlet 124 of the pump 110 in fluid communication with a lower portion of the tank 112.

In some embodiments, a collection unit may include a sensor. For example, a water level sensor may include a float 109 and/or a switch 122. For example, when the water level gets high, the sensor may turn on the switch 122 and pump water out. Alternatively or additionally, the sensor may send water level data to a processor (for example a part of control unit 115) that decides when and how much to pump. In some embodiments, water sensor output may be adjusted, for example to avoid instabilities. For example, level data may be averaged and/or integrated over time to inhibit instabilities in pumping due to transient changes in water level (e.g., as a result of sloshing in a moving vehicle. Optionally the control unit 115 includes transmitter and/or receiver for communications with a remote unit. For example, the remote unit may include a sensor in the vehicle and/or a personal computing device of a user to for example as a user interface wherein the user can change settings and/or see sensor data.

FIG. 2A illustrates a windshield washer fluid reservoir cap in accordance with an embodiment of the current invention. In some embodiments, a water collecting unit 100 will be packaged and/or sold as a kit including connectors to a car. For example, the kit may include a custom reservoir cover 229. For example, cover 229 may include a quick connector 205 and/or a one way valve to facilitate introducing water from a collecting unit (e.g., unit 100) to the wiper fluid reservoir.

FIG. 2B illustrates a windshield washer fluid reservoir cap attachment 234 in accordance with an embodiment of the current invention. For example, attachment 234 may include a quick connector 205 and/or an attachment mechanism. For example, the attachment mechanism 226, For example, attachment mechanism 226 may include an interference element. Optionally, forms a hole in the existing reservoir (e.g., in a cap thereof) and/or inserts the interference element to the hole.

FIG. 3 is an illustration of a utility including a raised utility tank in a cargo section of the vehicle in accordance with an embodiment of the current invention. In some embodiments, water collected from a water source 317, for example, a vehicle air conditioner is collected in a collection tank 312 and/or pumped through a tube 308 to a utility tank 334 and/or to a reservoir of the vehicle (e.g., a windshield wiper reservoir). Optionally, the utility tank 334 is installed in the upper portion of the vehicle. For example, the utility tank may include a water tap 320 from which the water will flow gravitationally. Optionally, pumping is controlled by a control unit 315.

FIG. 4 is an illustration of a utility including a concealed utility tank in a cargo section of the vehicle in accordance with an embodiment of the current invention. In some embodiments, water collected from a vehicle air conditioner is collected in a collection tank 312 and/or pumped through a tube to a utility tank 434. Optionally, the utility tank 434 is concealed in the cargo portion of the vehicle. For example, the utility tank 434 may include a water tap 420 from which the water may be driven by a pump. For example, water may be driven by the same pump 410 that drives water to the utility tank 434 and/or the utility tank my include a dedicated pump. The pump 410 optionally raises the water to a convenient position in the vehicle where the tap 420 is installed. The utility tanks of the embodiments of FIGS. 3 and 4 may be used with any of the collection systems described herein.

FIG. 5 is a block diagram of a water exploitation system for a vehicle in accordance with an embodiment of the current invention. In some embodiments, the system includes a collection tank 512 that receives surplus water (for example air conditioner 532 condensate) from the vehicle. For example, water may be transported to the tank 512 through a condensate pipe 552. Optionally, quick connectors, replacement caps and the like are supplied for easy connections.

In some embodiments, sensors 509a, 509b, 509c record level data in the various tanks and/or reservoirs (e.g., a collection tank 512, utility tank 534 and/or car fluid reservoir 536 respectively) of the system. Data is optionally sent to a processor 511 (optionally over a wired connection and/or a wireless connection). Optionally, processor 511 may be configured to control pumping for water from the utility tank to a reservoir (e.g., a washer fluid reservoir 536 and/or a utility tank 534) according the level of water in the tanks 512, 534, 536. For example, processor 511 controls the pump 510 and/or a valve 538 to direct the water to the desired location. Alternatively or additionally, the processor 511 sends data to a transceiver 554 for transmission to a user interface (for example a cell phone and/or a user interface of the vehicle). Alternatively or additionally, the user sends instruction to the processor 511 via the user interface (for example, giving instruction to send water from one reservoir to another).

FIG. 6 is a block diagram of a vehicle water collection system in accordance with an embodiment of the current invention. In some embodiments, a collection tank is installed in a vehicle. For example, the collection tank may be positioned under the condensation outlet of the vehicle's air conditioning 632 system and/or hidden in different spaces in a lower portion of the vehicle. Optionally, water results from various process that occur in and/or around the vehicle (for example condensate from the vehicle's air-conditioning 632 system).

In some embodiments, water from the air conditioning 632 system flows only by gravity and/or flows through a flexible tube connecting the air-conditioning 632 system to the collection tank 612. Optionally, the tube includes an existing condensate collection tube.

In some embodiments, the collection tank 612 may be constructed in a rectangular and/or custom form. For example, the form of the tank 612 may be modified according to space constraints in the vehicle. For example, the tank 612 may be made of a plastic alloy and/or metal that is adapted to the standards in the automotive world and/or according to health standards for water storage. The structure and/or material may be adapted for strength and/or flexibility according to the nature of work in the various vehicles on which the system is installed. In some embodiments, the tank 612 may include an overflow channel (for example, including a tube such that if the tank is overfilled, it overflows below the vehicle and doesn't harm components of the vehicle and/or the collection system).

In some embodiments, a pump 610 pumps water from the collection tank to a utility tank 634 and/or various water reservoirs 636 in the car (for example, coolant and/or wiper fluid). For example, the utility tank 634, may output water to an outlet (e.g., a tap and/or an outlet with a connector for connecting to equipment that needs water). Alternatively or additionally, pump 610 may send water to the out 620. For example, the controller may receive information from sensors about the state of filling of the collection tank 612, the utility tanks 634 and/or the vehicle reservoirs 636. Optionally, based on that information the controller 611

In some embodiments, the system includes a controller 611. For example, the controller may control the pump 610 and/or a valve 638 to direct water from the pump 610 to one of the outlets 620, reservoirs 636 and/or tanks 634. Alternatively or additionally, there may be a user interface (for example, in the dashboard of the car and/or via a wireless transmitter to a personal computing device of a user) that may report the state of the collection tank 612, outlet 620, reservoirs 636 and/or tanks 634 and/or receive instructions for the user as to what to do with the water. In some embodiments, controller 611 may be part of a collection module attached to tank 612, and/or controller 611 may be mounted separately to the vehicle and/or controller 611 may include a remote processor (for example, an Internet server and/or a personal computing device of the user etc.).

In some embodiments, a pump may be used to pump water to an application. valve 638 may allow water to flow from utility tank 634 to the pump 610. For example, pump 610 may be used to pump water from utility tank 634 to an outlet 620 and/or a reservoir 636.

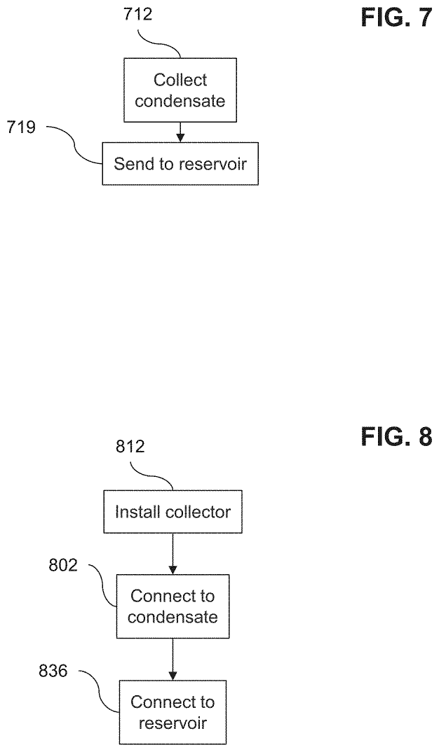

FIG. 7 is a flow chart illustration of a method of exploiting water in accordance with an embodiment of the current invention. In some embodiments, a collection unit (for example similar to any combination of those described herein e.g., FIGS. 1A, 1B, 2, 3, 4, 5, 9, 10, 11, 12) is used to collect 712 condensate (for example from air conditioner of a vehicle). Optionally the water is stored in a tank and/or sent 719 (e.g., pumped) to a reservoir of the vehicle and/or a utility tank. For example, the level of a tank and/or reservoir may be measured. Optionally, when the collection tank is full is full, water is sent 719 out. Alternatively or additionally, when a reservoir or tank is running low, water is sent 719 thereto.

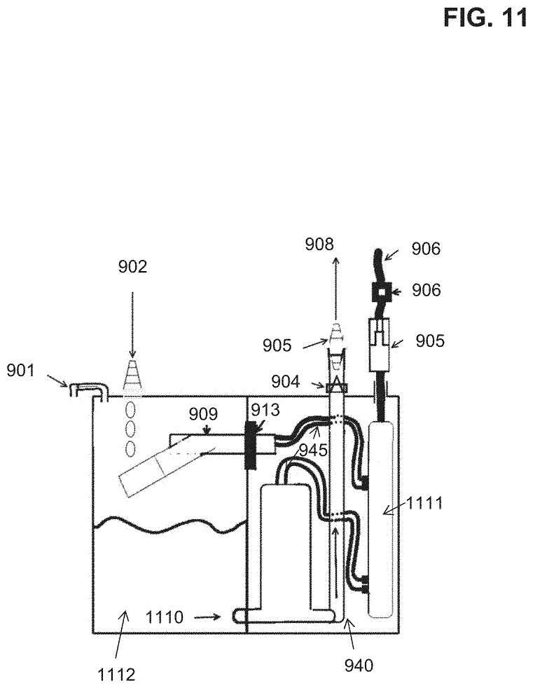

FIG. 8 is a flow chart illustration of a method of installing a system to exploit water in a vehicle in accordance with an embodiment of the current invention. In some embodiments, a collector is installed 812 into the vehicle. For example, the collector may include an integrated unit (for example as illustrated in FIGS. 1A, 1B, 11). Alternatively or additionally, a tank and/or a pump and/or a control unit may be installed 812 separately. Optionally, the collection unit and/or the collection tank are installed 812 below a fluid source (e.g., the air conditioner). In some embodiments, the system will be supplied as a kit including for example a collection unit, a mount therefore, connectors and/or a utility tank. Optionally the collection unit is connected 802 to a condensate source. For example, connection 802 may be by means of a flexible tube and/or a quick connector. In some embodiment, an outlet of the collector tank is connected 836 a reservoir. For example, the outlet may be connected 836 to an existing reservoir of the vehicle (e.g., a wiper fluid reservoir). For example, a special cover and/or connector (e.g., a quick connector) may be attached to the reservoir to make the connection. Alternatively or additionally, a water tank (e.g. a utility tank for example as illustrated in FIGS. 3, 4, 12). Optionally a pump is positioned between the collector and the reservoir and/or tank.

In some embodiments, the method may be used to retrofit an existing vehicle. For example, the system may include a wireless transceiver (for example built into the collector unit and/or sharing a power supply with a pump for example to reduce the number of components to install and/or reduce the number of connections that are required to the existing vehicle). For example, the user interface of the system may be a personal computing device of the user. Optionally, this will facilitate installation. For example, installation of an application software on a cell phone and/or wirelessly connecting to the system may be easier connecting the system to the vehicles electronic system.

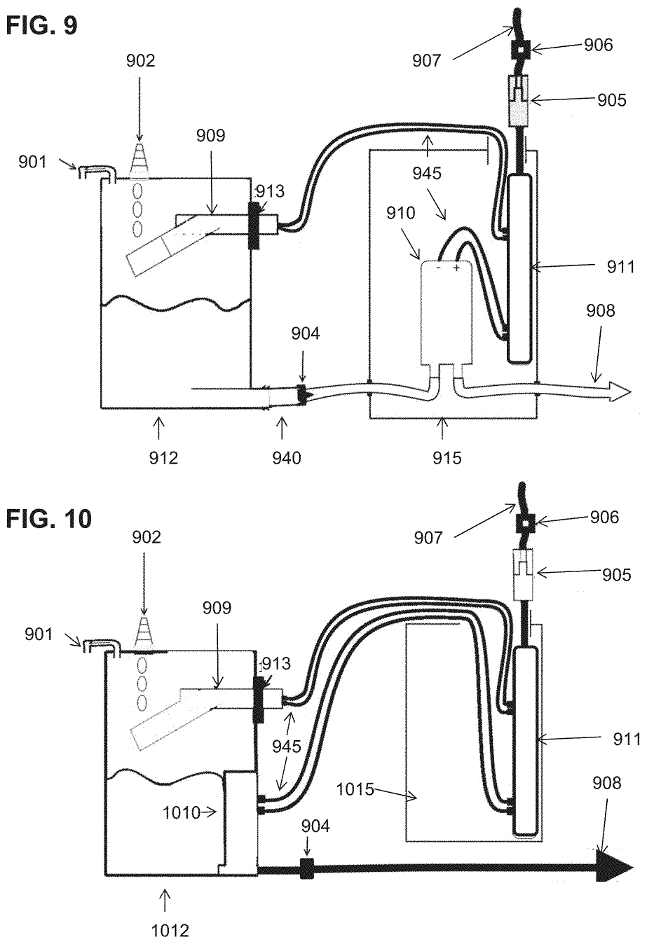

FIG. 9 is a schematic illustration of a water collection system in accordance with an embodiment of the current invention. For example, the system includes a collection tank 912. For example, the collection tank may be installed under the condensate drain of the vehicle's air conditioning system and/or hidden in different spaces at a lower portion of the vehicle. Tank 912 optionally collects the water created by the condensation process that occurs in the car's air-conditioning system.

In some embodiments, the water from the air conditioning system flows by gravity and/or through by a flexible tube (for example, the existing connection drain tube 902 of the air conditioner into tank 912.

Tank 912 is optionally rectangular and/or may have custom form in accordance with space constraints in the vehicle. Tank 912 is optionally made of a material (e.g., plastic, metal and/or an alloy) that is adapted to the automobile and/or water storage standards. Optionally the material, has of strength and flexibility according to the nature of work in the various vehicles on which the system is installed.

Inside tank 912, there is an optionally tube 940. For example, tube 940 is located at the lower part of the tank 912. For example, the water is drawn out through tube 940 when the tank 912 is full. Tube 940 is optionally concealed and/or protected so that it will not be damaged by shocks that may arise from driving.

In some embodiments, tank 912 includes a level sensor 909. In some embodiments, sensor 909 includes a float connected to a mechanical valve. Alternatively or additionally, an electronic sensor sends signal to a CPU 911 in a control unit 915. For example, sensor 909 may be installed at the top of tank 912. Sensor 909 optionally sends an operating signal according to the fluid level in the tank. The Sensor 909 optionally includes a screwing and/or sealing unit [e.g., a plug 913]. For example, plug 913 prevents leakage of water and/or reduces the chance that dust will get into the interior of the tank. In some embodiments, the buoy is installed manually by pressing and screwing.

In some embodiments, tank 912, includes a drainage faucet 901. For example, faucet 901 is positioned above the water level sensor 909. In some embodiments, faucet 901 drains overflow water, for example, in case of any technical failure in the system, thus inhibiting flooding in the vehicle's space. The faucet 901 is built in a way that inhibits dust from entering the system and/or keeps the water clean. For example, avoiding contact with the dust and liquids that exist in the vehicle environment. Keeping the water in tank 912 clean may inhibit erosion of the system components. Optionally, the faucet is configured for human use (for example for utility use washing objects and/or showering etc. and/or for attachment to a piece of equipment (e.g., a hose and/or an agricultural tank etc.).

In some embodiments, tank 912 is connected to the vehicle using clips that are vehicle-specific. For example, the clips may be configured to provide system stability and/or reliability and/or to inhibit vibration and/or noise from the affecting system while driving.

Optionally, a control unit 915 includes a pump 910 that pumps water from tank 912 to an outlet 908. Optionally a one way valve 904 prevents water from flowing back from pump 910 to tank 912. In some embodiments, the system include wiring 945. For example, wiring 945 may connect a sensor 909 to the control unit 915. For example, wiring 945 may supply control signals and/or power to pump 910.

FIG. 10 is a schematic illustration of a tank 1012 including an integrated pump 1010 in accordance with an embodiment of the current invention. For example, pump 1010 may be attached directly to the tank and/or located next to the tank. In some embodiments, pump 1010 draws the water from the bottom of tank 1012. The pump 1010 receives a power of 12V from the control unit 1015 with a processor 911. Optionally, control unit 1015 is installed above a vehicle's engine. Optionally, there is a flow of fresh air, to cool the various components.

In some embodiments, control unit 915 includes an electronic processor 911 and/or a water pump 1010 (e.g., see FIG. 9). Alternatively or additionally, control unit 1015 may include an electronic circuit 1011 which pump 1010 is part of the tank 1012. Optionally, tank 1012 and/or control unit 1015 are positioned in a designated location by a mount that is vehicle-specific. For example, the mount may be configured to inhibit vibrations that can damage the operation of the system.

In some embodiments, processor 1011 in configured for controlling timing of operation pump 1010. For example, a user interface (e.g., hard wired and/or via a wireless connection [e.g., via an application on a cell phone]), may be used to set the operation time and/or stop the operation of the pump 1010 according to the amount of fluid stored in tank 1012.

In some embodiments, the control unit 915, 1015 receives power (e.g., an electrical an input voltage of 12 v and/or 24 v) directly from the vehicle battery and/or from any power source in the vehicle. For example, the connection may include a feed cable 907. Optionally, input voltage will determine the output and working voltage of the system. A fuse 906 is optionally installed between the power source and the circuit to prevent a situation in which there is a technical failure in the pump 1010 or circuit 1015 that can cause shortening or warming of the tendons. In the event of an emergency, the fuse 906 burns and stops the voltage to the entire system. Optionally, a quick connector 905 is used between cable 907 and the control unit 915, 1015. For example, this may facilitate easy installation of the device.

The electronic control unit 1015 optionally has a voltage output that transfers voltage to operate the water pump 1010, and/or another exit to the water level sensor 909 installed in tank 1012.

In some embodiments, water pump 910, 1010 includes a high-pressure water pump 1010. For example, the entrance of the pump is attached to the water outlet shaft in the tank 1012 by a rubber tube that is suitable for hot conditions. The pump sucks the water and transfers it to other tanks in the vehicle (tanks A2 or A3).

The water pump [110] passes water to two tanks in the vehicle: tank A2 (wiper-fluid tank) and tank A3 (rear storage).

The water passes through a T-valve which regulates the flow of the water to the tanks. (In design)

In some embodiments, the control unit 1015 may include only the electronic components. For example, the pump 1010 may be connected to and/or integrated into the tank 1012.

FIG. 11 is a schematic illustration of a system in which the control unit 1115 is integrated into a tank 1112 in accordance with an embodiment of the current invention. For example, the system will include a fluid partition and a dry partition. The electronics 1111 and/or pump 1110 are optionally installed on the dry partition and/or a fluid level sensor may be installed on the wet partition.

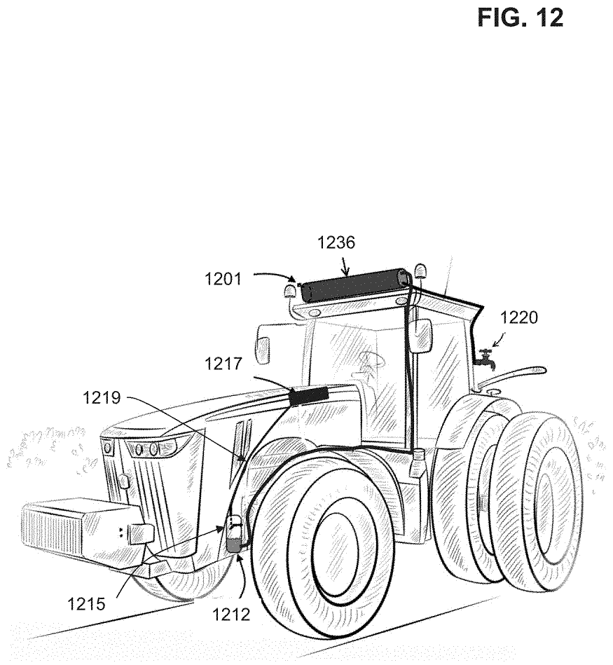

FIG. 12 is a schematic drawing of a water exploitation system mounted to utility vehicle in accordance with an embodiment of the current invention. For example, an agricultural vehicle (e.g., a tractor), a collector tank 1212 and/or a control unit 1215 are installed onto the tractor. Optionally, the tank receives water from a fluid source (for example a drip tube 1219 of an air conditioner evaporator 1217). Optionally a utility tank 1236 is positioned on the tractor (for example in an elevated position). Optionally, the utility tank has a cylindrical shape and/or is adapted to the type of vehicle. For example, the utility tank 1236 may be installed on the roof or the sides of the agricultural vehicle. Optionally the utility tank 1236 will have a capacity of between 10 and 30 liters or more. Optionally, a spigot 1220 is supplied to access the water. For example, water may flow from the utility tank 1236 to the spigot via gravitational flow. Optionally, in the embodiment of FIG. 12 and/or any of the other embodiments, there is a surplus faucet 1201 that allows water overflow in a way and to a location where damage will be inhibited if the tank is over filled.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for exploiting water in a vehicle comprising:
an integrated collector unit including a tank, a pump, a controller;
a fluid connection from the pump to a windshield washer reservoir of the vehicle;
a utility tank including a fluid outlet accessible for human use.

2. The system of claim 1, wherein said integrated collector unit further includes a water level sensor.

3. The system of claim 2, wherein said water levels sensor includes a mechanical switch that activates said pump in response to an output of the water level sensor.

4. The system of claim 2, wherein said water levels sensor sends an output to said controller.

5. The system of claim 1, further comprising a water levels sensor for said windshield washer reservoir and wherein said water levels sensor for said windshield washer reservoir sends an output to said controller.

6. The system of claim 1, further comprising a water levels sensor for said utility tank and wherein said sensor for said utility tank sends an output to said controller.

7. The system of claim 1, further including a modular mount facilitating mounting of said integrated collector unit to different vehicles.

8. The system of claim 7, wherein said modular mount is configured for absorbing vibration.

9. A method of collecting water in a vehicle comprising:
accumulating condensate to a collection tank; and
pumping said condensate from said collection tank to a reservoir in said vehicle when a level water in said collection tank reaches a threshold.

10. The method of claim 9, wherein said pumping is to a windshield washer reservoir.

11. The method of claim 10, wherein said pumping is to a utility tank including a fluid outlet accessible for human use on said vehicle.

12. The method of claim 10, wherein said accumulating is via gravity flow from an air conditioner of the vehicle.

13. A method of retrofitting a vehicle with a water accumulation system comprising:
mounting a water collection unit to the vehicle;
connecting in inlet of the water collection unit to a condensate collector of the vehicle;
connecting an outlet of the collection unit to a reservoir of the vehicle.

14. The method of claim 13 further comprising attaching a quick connector to said reservoir and attaching said connecting of the outlet is to said quick connector.

15. The method claim 14, wherein said attaching includes at least one of replacing a cap of said reservoir with a cap including said quick connector, forming a hole in the cap of said reservoir and inserting said quick connector into said hole, and forming a hole in said reservoir and inserting said quick connector into said hole.

16. The method of claim 13, further comprising:
mounting a utility tank on the vehicle and wherein said connecting said outlet includes connecting the outlet to the utility tank.

17. The method of claim 13, further including installing a user interface application onto a personal computing device of a user for use as a user interface of the water accumulation system.

18. The method of claim 13, wherein said mounting is below a water source such that water flows from said water source to said collection unit by gravity flow.

19. A kit for retrofitting a vehicle for water collection comprising:
an integrated collector unit including a tank, a pump, a controller;
a replacement cap for a water reservoir of the vehicle including a connection for input from the collector unit.

20. The kit of claim 19, wherein said integrated collector unit further comprises a transceiver configured to communicate data to a mobile computing device of a user.
